(19) United States
(12) Patent Application Publication
(10) Pub. No.: US 2020/0192050 A1
(43) Pub. Date: Jun. 18, 2020

(54) LENS MODULE

(71) Applicant: TRIPLE WIN TECHNOLOGY (SHENZHEN) CO.LTD., Shenzhen (CN)

(72) Inventors: KUN LI, Shenzhen (CN); SHIN-WEN CHEN, Tu-Cheng (TW); YU-SHUAI LI, Shenzhen (CN); LONG-FEI ZHANG, Shenzhen (CN)

(21) Appl. No.: 16/249,001

(22) Filed: Jan. 16, 2019

(30) Foreign Application Priority Data
Dec. 15, 2018 (CN) 201811537580.2

(51) Int. Cl. G02B 7/02; G03B 3/10; G02B 5/20; G02B 7/00; G02B 7/09; G02B 13/00

(52) U.S. Cl. CPC G02B 7/021; G03B 3/10; G02B 5/20; H02K 41/0356; G02B 7/09; G02B 13/001; G02B 7/006

(57) ABSTRACT

A lens module includes a circuit board, a carrier, and a filter. The carrier is mounted to a surface of the circuit board and includes a through hole. The filter is mounted within the through hole. The carrier includes at least one air hole passing through the carrier. The filter and the circuit board close respective opposite sides of the carrier to form a receiving space. The air hole connects to the receiving space to allow heat from within the receiving space to be released out.

### FIELD

The subject matter herein generally relates to a lens module.

### BACKGROUND

Generally, a lens module includes a lens, mirror mounts, carriers, filters, sensors, and circuit boards. Heat generated by the lens module may result in a temperature difference between an inner and an outer surface of the filter, and condensation formed on the inner surface of the filter may affect the image quality of the lens module.

### BRIEF DESCRIPTION OF THE DRAWINGS

Implementations of the present disclosure will now be described, by way of embodiments, with reference to the attached figures.

FIG. 1 is an isometric view of an embodiment of a lens module.

FIG. 2 is an exploded view of the lens module in FIG. 1.

FIG. 3 is a cross-sectional view of the lens module in FIG. 1 taken along line III-III.

FIG. 4 is an isometric view of an electronic device including the lens module.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

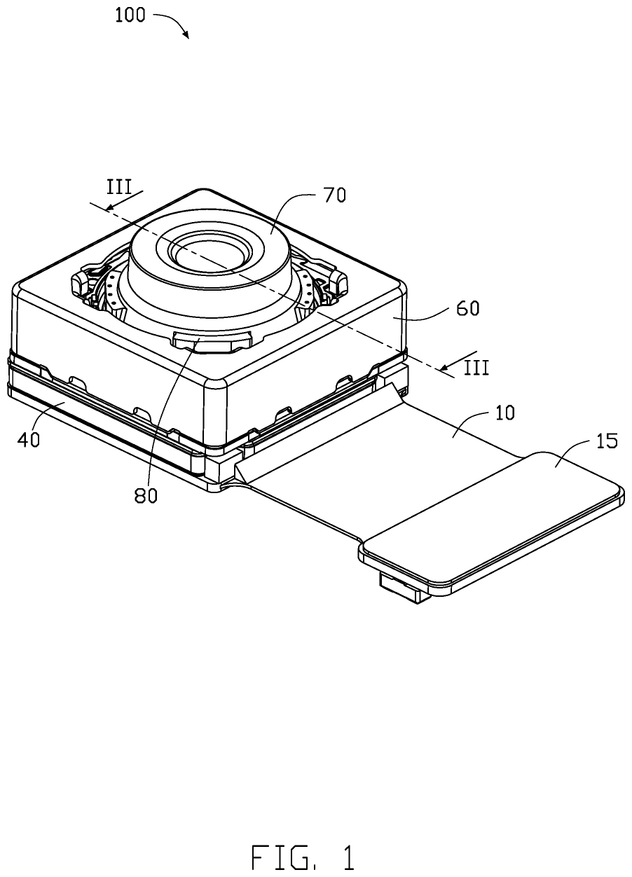

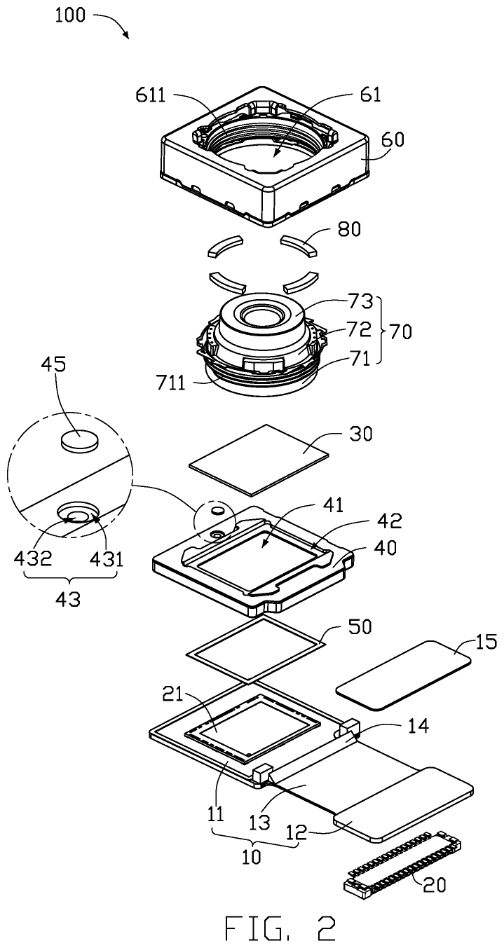

FIG. 1 and FIG. 2 show an embodiment of a lens module 100. The lens module 100 includes a circuit board 10, a filter 30, a carrier 40, a voice coil motor 60, and a lens 70.

The circuit board 10 may be a flexible board, a hard board, or a flexible-hard composite board. In one embodiment, the circuit board 10 is a flexible-hard composite board and includes a first hard section 11, a second hard section 12, and a flexible section 13 coupled between the first hard section 11 and the second hard section 12. An electrical connecting portion 20 is mounted on a surface of the second hard section 12. When the lens module 100 is applied in an electronic device, the electrical connecting portion 20 is configured to implement signal transmission between the lens module 100 and other components of the electronic device. The electrical connecting portion 20 can be a connector or a gold finger. A reinforcing plate 15 is mounted on another surface of the second hard section 12. The reinforcing plate 15 is made of metal, such as stainless steel.

A surface of the first hard section 11 is mounted with a photosensitive chip 21. The photosensitive chip 21 and the electrical connecting portion 20 are located on different surfaces of the circuit board 10. In one embodiment, a shape of the photosensitive chip 21 is a rectangle.

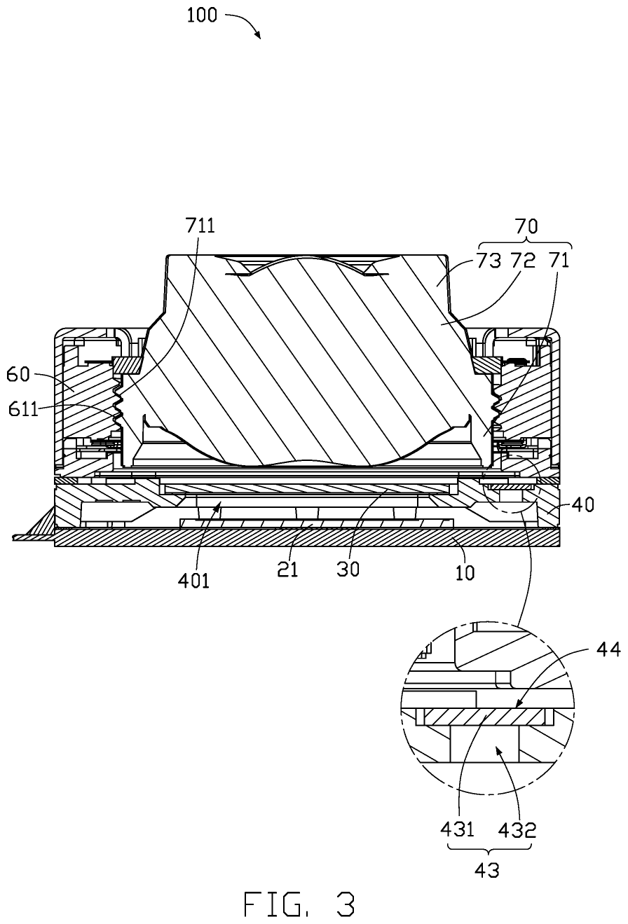

As shown in FIG. 3, the carrier 40 is mounted on a surface of the first hard section 11 of the circuit board 10 and is located on the same surface of the circuit board 10 as the photosensitive chip 21. The carrier 40 is substantially hollow rectangular. The carrier 40 includes a through hole 41 (shown in FIG. 2). A portion of the surface of the carrier 40 facing away from the circuit board 10 and adjacent to the through hole 41 is recessed inwardly to form a recess 42. The carrier 40 includes at least one air hole 43 passing through the carrier 40 on a side of the through hole 41. An axis of the air hole 43 is substantially parallel to an axis of the through hole 41. Each of the air holes 43 may have a substantially stepped structure. In one embodiment, each of the air holes 43 includes a first air hole 431 and a second air hole 432. The first air hole 431 is defined in a surface of the carrier 40 facing away from the circuit board 10 to form an opening 44 in the surface, and the second air hole 432 is in a bottom of the first air hole 431 and connected to the first air hole 431. A width of the first air hole 431 is greater than a width of the second air hole 432. A gas permeable structure 45 is arranged in the first air hole 431. The gas permeable structure 45 may be a gas permeable membrane or a gas permeable mesh. The gas permeable membrane and the gas permeable mesh are dustproof, waterproof, and breathable. The gas permeable membrane and the gas permeable mesh may be made of a polymer material having a waterproof and gas permeable function such as expanded polytetrafluoroethylene (EPTFE fine powder resin). The carrier 40 can be composed of metal or plastic. In one embodiment, the carrier 40 is made of plastic.

The filter 30 is mounted in the recess 42 of the carrier 40 and spaced from the photosensitive chip 21. In one embodiment, the filter 30 is rectangular. The filter 30 and the circuit board 10 respectively cover opposite sides of the through hole 41 to form a receiving space 401. The photosensitive chip 21 and electronic components of the circuit board 10 can be accommodated in the receiving space 401. The air hole 43 connects the opening 44 and the receiving space 401 together. The air hole 43 dissipates heat generated in the receiving space 401 due to operation of an electronic component (not shown) on the circuit board 10 through the air permeable structure 45 and the opening 44, thereby preventing formation of water moisture on the filter 30 and the photosensitive chip 21 as a result of a temperature difference between inner and outer surfaces of the filter 30, thereby improving an image quality of the lens module 100. The gas permeable structure 45 can also prevent debris from outside the receiving space 401 falling onto the photosensitive chip 21 in the receiving space 401, thereby ensuring the image quality of the lens module 100.

The lens module 100 further includes a strength enhancing gel 14. The strength enhancing gel 14 is located on the same surface of the circuit board 10 as the carrier 40. The strength enhancing gel 14 is connected to the carrier 40. The strength enhancing gel 14 reinforces a mechanical strength of the circuit board 10, such as the mechanical strength of the flexible section 13.

The voice coil motor 60 is mounted on a surface of the carrier 40 facing away from the circuit board 10. The voice coil motor 60 has a substantially rectangular structure. The voice coil motor 60 includes an accommodating hole 61. The voice coil motor 60 is made of metal or plastic. In one embodiment, the voice coil motor 60 is made of metal. A first thread 611 is arranged on an inner wall of the accommodating hole 61.

The lens 70 is partially received in the accommodating hole 61 of the voice coil motor 60. The lens 70 and the voice coil motor 60 are assembled or integrally formed. In one embodiment, the lens 70 and the voice coil motor 60 are assembled together. The lens 70 includes a first lens portion 71, a second lens portion 72, and a third lens portion 73. The second lens portion 72 is coupled between the first lens portion 71 and the third lens portion 73. A second thread 711 is arranged at a junction between the first lens portion 71 and the second lens portion 72. The second thread 711 and the first thread 611 cooperatively mount the lens 70 in the accommodating hole 61. The voice coil motor 60 has an autofocus function that can adjust a position of the lens 70 mounted in the voice coil motor 60. A diameter of the first lens portion 71, the second lens portion 72, and the third lens portion 73 sequentially decreases. The lens 70 is formed by assembling the first lens portion 71, the second lens portion 72, and the third lens portion 73 together or by being integrally formed. In one embodiment, the first lens portion 71, the second lens portion 72, and the third lens portion 73 of the lens 70 are integrally formed to form the lens 70. In one embodiment, the first lens portion 71 is received in the accommodating hole 61, the second lens portion 72 is partially received in the accommodating hole 61, and the third lens portion 73 is arranged outside of the accommodating hole 61.

In one embodiment, the lens module 100 further includes a mounting gel 80. The mounting gel 80 is received in the accommodating hole 61 and surrounds the second lens portion 72. The mounting gel 80 mounts the lens 70 to prevent the lens 70 from coming out of focus.

In other embodiments, the carrier 40 does not form the recess 42, such that the filter 30 is directly mounted on the carrier 40 or assembled within the carrier 40, such as by an adhesive applied between an outer peripheral wall of the filter 30 and an inner peripheral wall of the carrier 40, by interference-fitting between the outer peripheral wall of the filter 30 and the inner peripheral wall of the carrier 40, or by a combination thereof or other means.

In other embodiments, the gas permeable structure 45 can be another gas permeable structure. In one embodiment, the gas permeable membrane is not provided, and an air hole cover is provided, as long as the air hole 43 can connect to the receiving space 401 to release the heat generated by the electronic components (not shown) in the receiving space 401 and the water vapor can be released. When the lens module 100 is used, the air hole cover is removed to expose the air hole 43 so that the heat and moisture generated during operation of the electronic components (not shown) in the receiving space 401 can be released. When the lens module 100 is not in use, the air hole cover covers the air hole 43 to prevent debris from outside the receiving space 401 falling onto the photosensitive chip 21 in the receiving space 401, thereby improving the image quality of the lens module 100.

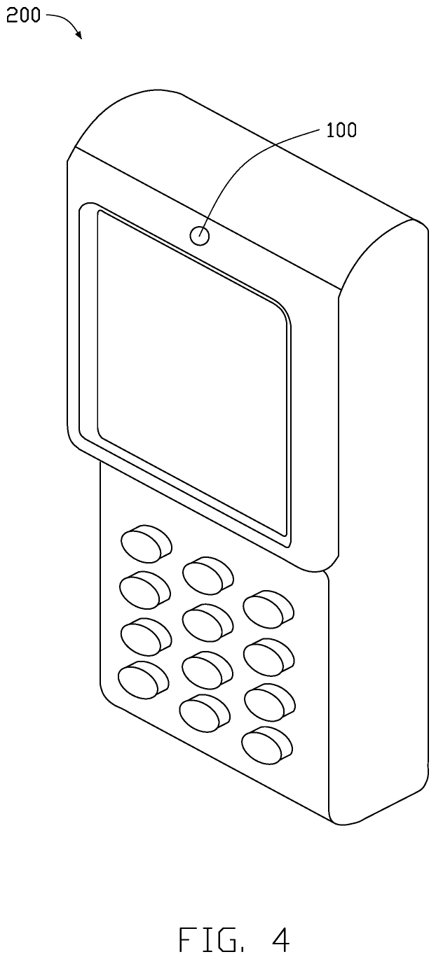

As shown in FIG. 4, the lens module 100 can be applied in an electronic device 200 having a camera module, such as a mobile phone, a wearable device, a computing device, a vehicle, or a monitoring device. In one embodiment, the electronic device 200 is a mobile phone.

The lens module 100 as described above includes the gas permeable structure 45 arranged in the air hole 43 defined in the carrier 40, and the air hole 43 is used to release heat and moisture generated during operation of an electronic component (not shown) in the receiving space 401 through the permeable structure 45. The gas permeable structure 45 can also prevent external debris from dropping onto the photosensitive chip 21 in the receiving space 401, thereby improving the image quality of the lens module 100.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A lens module comprising:
a circuit board;
a carrier mounted to a surface of the circuit board and comprising a through hole; and
a filter mounted within the through hole; wherein:
the carrier comprises at least one air hole passing through the carrier;
the filter and the circuit board close respective opposite sides of the carrier to form a receiving space;
the air hole is connected to the receiving space to allow heat from within the receiving space to be released out.

2. The lens module of claim 1 further comprising a gas permeable structure arranged in each of the air hole.

3. The lens module of claim 2, wherein the gas permeable structure is a gas permeable membrane or a gas permeable mesh.

4. The lens module of claim 3, wherein:
each of the air hole comprises a first air hole and a second air hole;
the first air hole is defined in a surface of the carrier facing away from the circuit board and forms an opening in the surface of the carrier facing away from the circuit board;
the second air hole is defined in a bottom of the first air hole and is connected to the first air hole;
a width of the first air hole is greater than a width of the second air hole;
the gas permeable structure is arranged within the first air hole.

5. The lens module of claim 2, wherein;
a surface of the carrier facing away from the circuit board and adjacent to the through hole is recessed inwardly to form a recess; and
the filter is mounted within the recess.

6. The lens module of claim 1, wherein:
the circuit board is a hard-flexible composite board comprising a first hard section, a second hard section, and a flexible section;
the flexible section is coupled between the first hard section and the second hard section;
a surface of the second hard section comprises an electrical connecting portion;
a surface of the first hard section comprises a photosensitive chip;
the photosensitive chip and the electrical connecting portion are arranged on different surfaces of the circuit board;
the photosensitive chip is received within the receiving space.

7. The lens module of claim 6, wherein:
the carrier is mounted on a surface of the first hard section of the circuit board; and
the carrier is arranged on a same surface of the circuit board as the photosensitive chip.

8. The lens module of claim 1 further comprising a strength enhancing gel arranged on a surface of the circuit board; wherein:
the strength enhancing gel is arranged on a same surface of the circuit board as the carrier; and
the strength enhancing gel is coupled to the carrier.

9. The lens module of claim 8 further comprising a voice coil motor and a lens; wherein:
the voice coil motor is mounted on a surface of the carrier facing away from the circuit board;
the voice coil motor comprises an accommodating hole; and
the lens is mounted within the accommodating hole.

10. The lens module of claim 9, wherein:
the accommodating hole comprises a first thread on an inner wall thereof;
the lens comprises a first lens portion, a second lens portion, and a third lens portion;
the lens comprises a second thread located at a junction between the first lens portion and the second lens portion;
the first lens portion is received within the accommodating hole;
the second lens portion is partially received within the accommodating hole;
the third lens portion is positioned outside of the accommodating hole;
the second thread is screwed with the first thread to mount the lens within the accommodating hole.

11. The lens module of claim 10 further comprising a mounting gel received within the accommodating hole and surrounding the second lens portion.

12. An electronic device comprising a lens module comprising:
a circuit board;
a carrier mounted to a surface of the circuit board and comprising a through hole; and
a filter mounted within the through hole; wherein:
the carrier comprises at least one air hole passing through the carrier;
the filter and the circuit board close respective opposite sides of the carrier to form a receiving space;
the air hole connected to the receiving space to allow heat from within the receiving space to be released out.

13. The electronic device of claim 12, wherein:
the lens module further comprises a gas permeable structure arranged in each air hole; and
the gas permeable structure is a gas permeable membrane or a gas permeable mesh.

14. The electronic device of claim 13, wherein:
each air hole comprises a first air hole and a second air hole;
the first air hole is defined in a surface of the carrier facing away from the circuit board a forms an opening in the surface of the carrier facing away from the circuit board;
the second air hole is defined in a bottom of the first air hole and is connected to the first air hole;
a width of the first air hole is greater than a width of the second air hole;
the gas permeable structure is arranged within the first air hole.

15. The electronic device of claim 13, wherein;
a surface of the carrier facing away from the circuit board and adjacent to the through hole is recessed inwardly to form a recess; and
the filter is mounted within the recess.

16. The electronic device of claim 12, wherein:
the circuit board is a hard-flexible composite board comprising a first hard section, a second hard section, and a flexible section;
the flexible section is coupled between the first hard section and the second hard section;
a surface of the second hard section comprises an electrical connecting portion;
a surface of the first hard section comprises a photosensitive chip;
the photosensitive chip and the electrical connecting portion are arranged on different surfaces of the circuit board;
the photosensitive chip is received within the receiving space.

17. The electronic device of claim 16, wherein:
the carrier is mounted on a surface of the first hard section of the circuit board; and
the carrier is arranged on a same surface of the circuit board as the photosensitive chip.

18. The electronic device of claim 12, wherein:
the lens module further comprises a strength enhancing gel arranged on a surface of the circuit board;
the strength enhancing gel is arranged on a same surface of the circuit board as the carrier; and
the strength enhancing gel is coupled to the carrier.

19. The electronic device of claim 18, wherein:
the lens module further comprises a voice coil motor and a lens;
the voice coil motor is mounted on a surface of the carrier facing away from the circuit board;
the voice coil motor comprises an accommodating hole; and
the lens is mounted within the accommodating hole.

20. The electronic device of claim 19, wherein:
the accommodating hole comprises a first thread on an inner wall thereof;
the lens comprises a first lens portion, a second lens portion, and a third lens portion;
the lens comprises a second thread located at a junction between the first lens portion and the second lens portion;
the first lens portion is received within the accommodating hole;
the second lens portion is partially received within the accommodating hole;
the third lens portion is positioned outside of the accommodating hole;
the second thread is screwed with the first thread to mount the lens within the accommodating hole; and
the lens module further comprises a mounting gel received within the accommodating hole and surrounding the second lens portion.
